(19) United States
(12) Patent Application Publication
(10) Pub. No.: US 2005/0041349 A1
(43) Pub. Date: Feb. 24, 2005

(54) Overvoltage protection device

(75) Inventors: Christian Birkholz, Lippetal (DE); Rainer Durth, Horn-Bad Meinberg (DE); Martin Wetter, Detmold (DE); Joachim Wosgien, Loehne (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Phonenix Contact GmbH & Co. KG, Blomberg (DE)

(21) Appl. No.: 10/499,609

(22) PCT Filed: Dec. 16, 2002
(86) PCT No.: PCT/EP02/14294

(30) Foreign Application Priority Data
Dec. 17, 2001 (DE) 101 62 149.3
Mar. 21, 2002 (DE) 102 12 697.6

(51) Int. Cl. H02H 9/04

(52) U.S. Cl. 361/91.1

(57) ABSTRACT

An overvoltage protection device includes two electrodes and an air breakdown spark gap between the electrodes. Also provided is a housing for the electrodes. An arc occurs in the air breakdown spark gap upon an ignition of the gap. An impedance is connected in parallel with the air breakdown spark gap so as to form a parallel arrangement. An insulating gap is connected in series with the parallel arrangement.

The present invention relates to an overvoltage protection device including a first electrode, a second electrode, and an air breakdown spark gap present or acting between the two electrodes; and further including a housing accommodating the electrodes; an electric arc being formed between the two electrodes when the air breakdown spark gap ignites.

Electrical, but especially electronic measurement, control and switching circuits, mainly also telecommunications equipment and systems, are sensitive to transient overvoltages, as can occur especially as a result of atmospheric discharges, but also due to short circuits and switching operations in power supply systems. This sensitivity has increased in the same measure that electronic components, especially transistors and thyristors, have been used; in particular, the integrated circuits which have been increasingly used are greatly endangered by transient overvoltages.

Electrical circuits normally operate without problems at the voltage specified for them, i.e., the rated voltage (as a rule ≅line voltage). This is not true when overvoltages occur. Overvoltages are considered to be all voltages which are above the upper tolerance limit of the rated voltage. They include mainly transient overvoltages which can occur not only from atmospheric discharges, but also from switching operations or short circuits in power supply systems. Such overvoltages can be galvanically, inductively or capacitively coupled into electrical circuits. In order to protect electrical or electronic circuits, especially electronic measurement, control and switching circuits, and, in particular, telecommunications equipment and systems—no matter where they are used—against transient overvoltages, overvoltage protection devices have been developed and in use for more than twenty years.

An important component of overvoltage protection devices of the type in question is at least one spark gap which arcs over at a certain overvoltage, i.e., the sparkover voltage, and thus prevents overvoltages which are larger than the sparkover voltage of the spark gap from occurring in the circuit protected by the overvoltage protection device.

It was explained at the outset that the overvoltage protection device according to the present invention has two electrodes and an air breakdown spark gap present or acting between the two electrodes. “Air breakdown spark gap” is understood to mean a breakdown spark gap in general, and is therefore intended to include also a breakdown spark gap where a gas other than air is present between the electrodes. Besides overvoltage protection devices having an air breakdown spark gap, there are overvoltage protection devices which have an air flashover spark gap and in which a creeping discharge occurs when the spark gap arcs over.

In comparison with overvoltage protection devices having an air flashover spark gap, the overvoltage protection devices having an air breakdown spark gap have the advantage of a greater surge current carrying capacity, but the disadvantage of a higher and not particularly constant sparkover voltage. Therefore, various overvoltage protection devices having an air breakdown spark gap have been proposed in the past which have been improved with respect to the sparkover voltage. Here, in the area of the electrodes or the air breakdown spark gap acting between the electrodes, ignition aids have been implemented in various ways, for example, by providing at least one ignition aid between the electrodes which triggers a creeping discharge and which projects at least partially into the air breakdown spark gap; the ignition aid being made in the form of a crosspiece of plastic (cf., e.g., Unexamined German Laid-Open Patent Applications 41 41 681 or 44 02 615).

The ignition aids which were addressed above and which are provided in the known overvoltage protection devices may be called, as it were, “passive ignition aids” because they do not themselves arc over “actively”, but only in response to an overvoltage occurring at the main electrodes.

Unexamined German Laid-Open Patent Application 198 03 636 also describes an overvoltage protection device having two electrodes, an air breakdown spark gap acting between the two electrodes, as well as an ignition aid. Unlike the ignition aids described above, which trigger a creeping discharge, the ignition aid of this known overvoltage protection device is designed as an “active ignition aid” in that, in addition to the two electrodes referred to as “main electrodes” there, two ignition electrodes are provided as well. These two ignition electrodes form a second air breakdown spark gap which serves as an ignition spark gap. In this known overvoltage protection device, the ignition aid includes an ignition circuit with an ignition switching element in addition to the ignition spark gap. When an overvoltage is present at the known overvoltage protection device, the ignition circuit with the ignition switching element causes the ignition spark gap to arc over. The ignition spark gap, i.e., the two ignition electrodes, are arranged with respect to the two main electrodes in such a manner that arcing-over of the ignition spark gap causes arc-over of the air breakdown spark gap between the two main electrodes, which is referred to as “main spark gap”. Arcing over of the ignition spark gap leads to ionization of the air present in the air breakdown spark gap so that after the ignition spark gap has arced over, the air breakdown spark gap between the main electrodes, i.e., the main spark gap, suddenly arcs over as well.

In the known, above-described types of overvoltage protection devices having ignition aids, the ignition aids lead to an improved, i.e., lower and more constant sparkover voltage.

In overvoltage protection devices of the type in question—whether with or without the use of an ignition aid—the electric arc that forms when the air breakdown spark gap is ignited produces a low-impedance connection between the two electrodes. Initially, the overvoltage discharge current to be discharged flows—intentionally—via this low-impedance connection. However, when line voltage is present, an unwanted line follow current ensues via this low-impedance connection so that the intention is for the arc to be quenched as soon as possible once the discharge process is completed. One way to achieve this objective is to increase the arc length and, thus, the arc voltage.

One way to quench the arc after the discharge process, namely to increase the arc length and thus the arc voltage, is implemented in the overvoltage protection device known from Unexamined German Laid-Open Patent Application 44 02 615. The overvoltage protection device described in Unexamined German Laid-Open Patent Application 44 02 615 has two narrow, angled electrodes which each have an arcing horn and a connecting leg angled therefrom. In addition, the arcing horns of the electrodes are provided with a hole in the area adjacent to their connecting legs. The holes provided in the arcing horns of the electrodes ensure that at the instant of arc-over, i.e., of igniting of the overvoltage protection element, the resulting arc is “set into motion” by a thermal pressure effect, causing it to migrate away from its point of origin. Since the arcing horns of the electrodes are arranged in a V-shape to one another, the gap to be bridged by the arc is thus increased as the arc migrates away, thereby increasing the arc voltage as well. However, this has the disadvantage that to achieve the desired increase in arc length, the geometrical dimensions of the electrodes must be sized accordingly so that the overvoltage protection device as a whole is bound to certain geometrical requirements.

A further possibility of quenching the arc after the discharge process is to cool the arc by the cooling effect of insulation walls and the use of gas-emitting insulating materials. In this context, a strong flow of quenching gas is necessary, requiring a high degree of structural complexity.

Furthermore, it is possible to increase the arc voltage by increasing the pressure. To this end, German Patent DE 196 04 947 C1 proposes to select the volume inside the housing in such a manner that the pressure is increased by the arc to many times the atmospheric pressure. In this context, the increase in the follow-current quenching capacity is achieved through pressure-dependent influencing of the arc field strength. However, in order for this overvoltage protection device to function in a reliable manner, on the one hand, a highly pressure-resistant housing is required and, on the other hand, the line voltage level must be known very accurately to be able to dimension the volume inside the housing accordingly.

When in overvoltage protection devices of the type in question, the arc is quenched, then, indeed, the low-impedance connection between the two electrodes is initially interrupted, but the space between the two electrodes is almost completely filled with plasma. However, due to the presence of plasma, the sparkover voltage between the two electrodes is decreased to such an extent that the presence of operating voltage may already lead to reigniting of the air breakdown spark gap. This problem occurs especially if the overvoltage protection device has an enclosed or semi-open housing because cooling or escape of the plasma is prevented by the essentially closed housing.

In order to prevent the overvoltage protection device, i.e., the air breakdown spark gap, from reigniting, different measures have been taken in the past to drive away or cool the ionized gas cloud from the ignition electrodes. To this end, structurally complex labyrinths and heat sinks have been used, making the manufacture of the overvoltage protection device more expensive.

It is therefore an object of the present invention to provide an overvoltage protection device of the type described at the outset, which has the feature of a high line follow current quenching capacity, but which nevertheless can be implemented in a structurally simple way.

The overvoltage protection device according to the present invention, in which the above-described objective is achieved, is first of all and essentially characterized in that an impedance is connected in parallel with the air breakdown spark gap, and in that an insulating gap is connected in series with the parallel circuit of the air breakdown spark gap and the impedance.

As in the prior art, the overvoltage protection device according to the present invention is connected in parallel with the input of the circuit or system or device to be protected. Thus, the—two-pole—overvoltage protection device is electrically, or to be more precise, galvanically coupled to the leads or terminals between which the line voltage is present during normal operation. As is not unusual, the first lead or the first terminal are hereinafter also referred to as “live” while the second lead or the second terminal are also denoted as “ground”. Using this terminology, it is assumed that, normally, the first electrode of the overvoltage protection device is connected or to be connected to the live lead or terminal, and that the second electrode of the overvoltage protection device is connected or to be connected to ground. Of course, the connection of the overvoltage protection device according to the present invention can also be done the other way around, and the overvoltage protection device according to the present invention can, of course, not only be used to protect electric circuits in which the line voltage is an AC voltage; but rather, the overvoltage protection device according to the present invention can be used without problems if the line voltage of the circuit to be protected is a DC voltage.

The impedance which is connected in parallel with the air breakdown spark gap would, by itself, result in that when the rated voltage (line voltage) of the circuit to be protected by the overvoltage protection device is present, the overvoltage protection device would become conductive as a whole because the air breakdown spark gap, which is non-conductive at line voltage, would be “short-circuited” by the parallel impedance. However, since an insulating gap is connected in series with the parallel circuit of the air breakdown spark gap and the impedance, it is guaranteed that the overvoltage protection device as a whole is not conductive when the rated voltage is present. In this context, the insulating gap is designed to be non-conductive at the rated voltage, but to become conductive when an overvoltage occurs.

If now an overvoltage greater than the in the sparkover voltage occurs at the overvoltage protection device according to the present invention, then the air breakdown spark gap connected in parallel with the impedance becomes conductive, that is, an arc is formed between the two electrodes of the air breakdown spark gap. Initially, the overvoltage discharge current to be discharged flows via the resulting low-impedance connection.

When line voltage is present, then the unwanted line follow current would flow via the low-impedance connection between the two electrodes. However, due to the overvoltage present before, now the insulating gap has also become conductive. Initially, this causes the line follow current to be distributed among the paralleled air breakdown spark gap and impedance. As a result of this, only part of the line follow current will flow via the air breakdown spark gap, which consequently leads to a decrease in the arc current which, in turn, results in an increase in the impedance of the arc. When the impedance of the arc, and thus the impedance of the air breakdown spark gap, increases, then this results in that the component of the line follow current flowing via the parallel impedance increases, and in that the component flowing via the air breakdown spark gap decreases further, respectively, so that the arc current also decreases further, as a result of which the arc is finally completely quenched.

In a first preferred embodiment of the overvoltage protection device according to the present invention, the impedance is formed by a resistor located in the discharge space between the two electrodes. The insulating gap can be structurally implemented in a particularly simple way by providing a third electrode between the first electrode and the resistor so that a second air breakdown spark gap which acts as an insulating gap is formed between the first electrode and the third electrode.

In a second, alternative embodiment of the overvoltage protection device according to the present invention, the insulating gap is implemented by a voltage-switching element.

The voltage-switching element is selected, i.e., rated such that it is non-conductive at the rated voltage, but becomes conductive, i.e., “switches” at the sparkover voltage of the overvoltage protection device. A varistor, a suppressor diode, or a gas-filled voltage arrester can be provided as the voltage-switching element. However, it is also possible to provide the voltage-switching element in the form of a combination of a varistor and a suppressor diode, a combination of a varistor and a gas-filled overvoltage arrester, a combination of a suppressor diode and a gas-filled overvoltage arrester, or a combination of varistor, a suppressor diode and a gas-filled overvoltage arrester.

Thus, the selection and rating of the voltage-switching element allows the paralleled impedance to be easily adapted to the two parameters rated voltage and sparkover voltage.

The resistor that forms the impedance is composed of a material which is electrically conductive and arc-resistant so that it is not destroyed when an arc occurs in the overvoltage protection device. The resistor is preferably composed of a conductive plastic, or a metallic material, or of a conductive ceramic material. The resistor can be made, for example, of a POM-Teflon plastic which is given the desired conductivity by the addition of carbon black. Moreover, the resistor can also be made of materials having a non-linear resistance behavior.

Specifically, the overvoltage protection device according to the present invention can be embodied and refined in many ways. In this regard, on the one hand, reference is made to the patent claims that are subordinate to Patent Claim 1 and, on the other hand, to the following description of preferred exemplary embodiments in conjunction with the drawing, in which

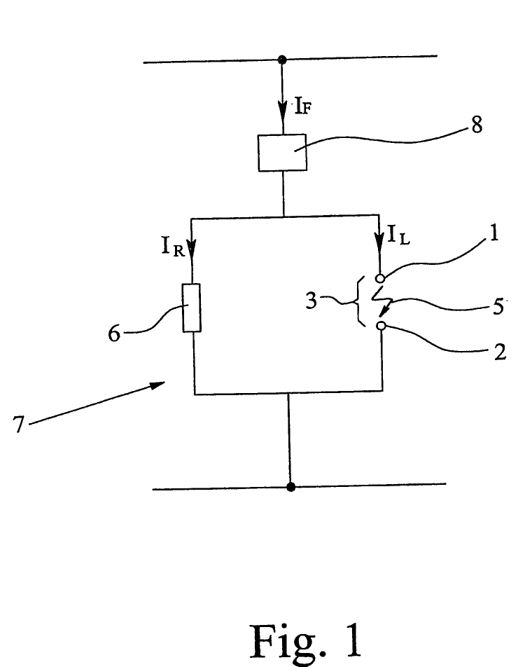

FIG. 1 shows a greatly simplified principle of operation of the arrangement of the impedance in an overvoltage protection device according to the present invention;

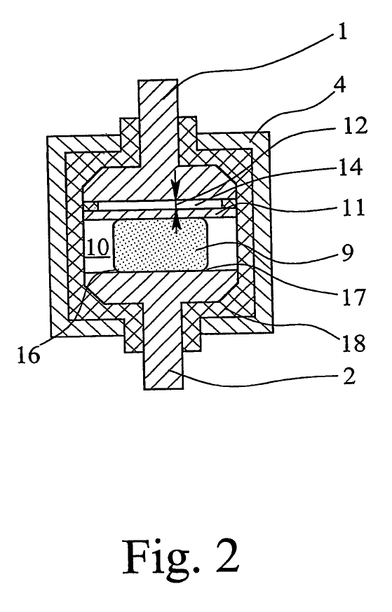

FIG. 2 is a schematic diagram of a first exemplary embodiment of an overvoltage protection device according to the present invention; and

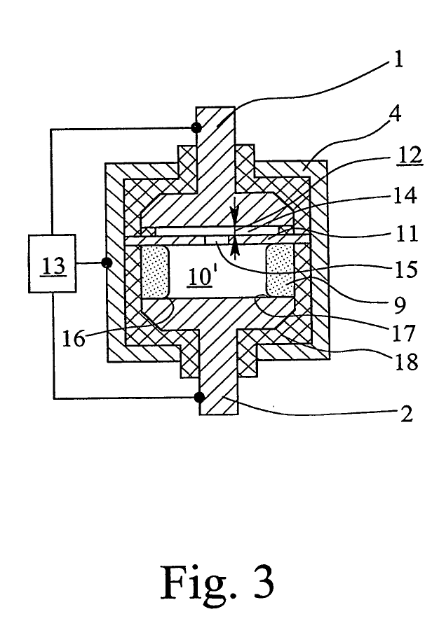

FIG. 3 is a schematic diagram of a second exemplary embodiment of an overvoltage protection device according to the present invention.

FIG. 1 shows a greatly simplified equivalent circuit diagram of a portion of the overvoltage protection device according to the present invention. The overvoltage protection device, which, as in FIGS. 2 and 3, is only shown with respect to its basic design, includes a first electrode 1, a second electrode 2, and an air breakdown spark gap 3 present or acting between the two electrodes 1 and 2. In addition, the overvoltage protection device has a housing 4 (not shown in FIG. 1) accommodating the electrodes 1, 2. In the overvoltage protection device according to the present invention, just as in the case of overvoltage protection devices on which the present invention is based, an arc 5 (only shown in FIG. 1) is formed between the two electrodes 1 and 2 when the air breakdown spark gap ignites. According to the present invention, an impedance 6, which also located in housing 4, is connected in parallel with the air breakdown spark gap 3, and an insulating gap 8 is connected in series with the parallel circuit 7 of air breakdown spark gap 3 and impedance 6.

According to FIGS. 2 and 3, impedance 6 is formed by a resistor 9 located in the discharge space 10 inside housing 4. Insulating gap 8 implemented by providing a third electrode 11 between first electrode 1 and resistor 9 so that a second air breakdown spark gap 12 which acts as the insulating gap 8 is present or acting between first electrode 1 and the third electrode 11.

In the overvoltage protection device according to the present invention, a line follow current I_{F} is prevented, or a line follow current I_{F} that has occurred is quenched, because impedance 6 is connected in parallel with air breakdown spark gap 3. If an overvoltage equal to or greater than the selected sparkover voltage occurs at the overvoltage protection device according to the present invention, then both air breakdown spark gap 3 and insulating gap 8, i.e., second air breakdown spark gap 9, become conductive in that an arc is formed between first electrode 1 and second electrode 2 in the simplified principle of operation according to FIG. 1, or between first electrode 1 and third electrode 11 as well as between third electrode 11 and second electrode 2, respectively. Since impedance 6 is connected in parallel with air breakdown spark gap 3, a flowing line follow current I_{F} is split into the two partial currents I_{L} (current of arc 5) and I_{R} (current across the impedance 6). The division of line follow current I_{F} already results in a first reduction in the current I_{L} of arc 5.

Due to the negative differential resistance of the arc, a reduction in the current I_{L} of arc 5 results in an increase in the impedance of arc 5, i.e., of air breakdown spark gap 3. If now the impedance of the leg of the parallel circuit 7 formed by air breakdown spark gap 3 is increased, then this causes the current I_{R} via impedance 6 to increase with respect to the current I_{L} of arc 5. Thus, the component of line follow current I_{F} flowing via the paralleled impedance 6 increases. The resulting further reduction of the current I_{L} of arc 5 leads to a further increase in the impedance of arc 5, i.e., of air breakdown spark gap 3, until arc 5 is finally completely quenched. Impedance 6 limits the current flow to such an extent that insulating gap 8 is quenched, as a result of which the overvoltage protection device as a whole is no longer conductive, and thus the line follow current I_{F} is quenched.

Knowing the characteristic of arc 5, one skilled in the art can select resistor 9 considering the volume of the overvoltage protection device, the spacing of electrodes 1, 2, and 11, the line voltage, and the expected short-circuit current in such a manner that a line follow current is I_{F} is completely prevented, if possible, or that a line follow current I_{F} that has occurred is quenched within the shortest time possible. Resistor 9 can be composed of a conductive plastic, or a metallic material, or of a conductive ceramic material, and is provided, on the one hand, with the desired conductivity and, on the other hand, with the required arc resistance by suitable additives.

From the diagrams of preferred exemplary embodiments in FIGS. 2 and 3, it can be seen that the distance between first electrode 1 and third electrode 11 is smaller than the distance between third electrode 11 and second electrode 2; however, it is also possible to select different distances between the electrodes. The two embodiments according to the two FIGS. 2 and 3 differ from each other, first of all, in that in the embodiment of the overvoltage protection device according to FIG. 3, third electrode 11 is electrically conductively connected to an ignition switching element 13. With ignition switching element 13, third electrode 11 can be designed as an ignition aid, in which case third electrode 11, together with ignition switching element 13, constitutes an “active ignition aid”, as is described in the later published document DE 101 46 728.

From FIG. 3, it can also be seen that the space 14 between first electrode 1 and third electrode 11 is connected to the discharge space 10 between third electrode 11 and second electrode 2 via an opening 15. Such a connection of the two spaces 10, 14 promotes the igniting of one air breakdown spark gap 12, 3, when the other air breakdown spark gap 3, 12 has already ignited.

FIGS. 2 and 3 also show two different preferred geometrical forms of resistor 9; the resistor 9 according to the exemplary embodiment in FIG. 2 being essentially designed as a cylindrical block, and the resistor 9 according to FIG. 3 being designed a ring. This then results in an annular discharge space 10, or a cylindrical discharge space 10′, respectively. As can be seen both from FIG. 2 and from FIG. 3, the edges or borders 16 of resistor 9 that are in mechanical contact with electrodes 2 and 11 are rounded or beveled. In this manner, a gap 17 is formed between resistor 9 and electrode 2 and 11, respectively, as a result of which the surface field strength during the occurrence of an overvoltage is increased at the edges or borders 16 of resistor 9. When an overvoltage of sufficiently high current occurs, this current produces a discharge at the contact point between edge 16 of resistor 9 and the associated electrode 2, 11 because of the increased contact resistance, the discharge preionizing the contact area so that an arc is formed which bridges gap 17. Such an arc can then migrate along the edge of resistor 9, resulting in the igniting of air breakdown spark gap 3 between the two electrodes 2, 11. Thus, resistor 9 can not only be used to suppress an unwanted line follow current I_{F}, but in addition also as an ignition aid for the overvoltage protection device.

Finally, FIGS. 2 and 3 also show that housing 4, which is preferably designed as a metallic pressure housing, has an interior insulating housing 18. In the exemplary embodiment according to FIG. 3, third electrode 11 is connected to metallic pressure housing 4.

1-13: (canceled).

14: An overvoltage protection device comprising:
a first electrode;
a second electrode;
an air breakdown spark gap disposed between the second electrode and the first electrode, the air breakdown spark gap being configured so that an arc occurs upon an ignition of the air breakdown spark gap;
a housing configured to receive the electrodes;
an impedance connected in parallel with the air breakdown spark gap so as to form a parallel arrangement; and
an insulating gap connected in series with the parallel arrangement.

15: The overvoltage protection device as recited in claim 14 wherein the impedance includes a resistor disposed in a first discharge space disposed between the first electrode and the second electrode.

16: The overvoltage protection device as recited in claim 15 further comprising a third electrode disposed between the first electrode and the resistor so as to form a second air breakdown spark gap between the first electrode and the third electrode, the insulating gap including the second air breakdown spark gap.

17: The overvoltage protection device as recited in claim 16 wherein a first distance between the first electrode and the third electrode is smaller than a second distance between the third electrode and the second electrode.

18: The overvoltage protection device as recited in claim 16 wherein the resistor has a resistance value of a magnitude so as to distribute a line follow current among the air breakdown spark gap and the resistor so as to completely quench the arc.

19: The overvoltage protection device as recited in claim 16 wherein the third electrode is electrically conductively connected to an ignition switching element.

20: The overvoltage protection device as recited in claim 16 wherein:
the first discharge space is disposed between the third electrode and the second electrode; and
a second discharge space disposed between the first electrode and the third electrode is connected to the first discharge space.

21: The overvoltage protection device as recited in claim 14 wherein the insulating gap includes a voltage-switching element.

22: The overvoltage protection device as recited in claim 21 wherein the voltage-switching element includes at least one of a suppressor diode and a gas-filled overvoltage arrester.

23: The overvoltage protection device as recited in claim 15 wherein the resistor is in mechanical contact with at least one of the first electrode and the second electrode, and includes at least one of a conductive plastic, a metallic material and a conductive ceramic material.

24: The overvoltage protection device as recited in claim 15 further comprising a third electrode disposed between the first electrode and the resistor so as to form a second air breakdown spark gap between the first electrode and the third electrode, and wherein the resistor is in mechanical contact with at least one of the second electrode and the third electrode, the resistor including at least one of a conductive plastic, a metallic material and a conductive ceramic material.

25: The overvoltage protection device as recited in claim 14 wherein the impedance includes a resistor, the resistor including at least one of a substantially square block, a substantially rectangular block, and a ring shape.

26: The overvoltage protection device as recited in claim 23 wherein the resistor includes at least one rounded or beveled edge in mechanical contact with at least one of the first electrode and the second electrode.

27: The overvoltage protection device as recited in claim 24 wherein the resistor includes at least one rounded or beveled edge in mechanical contact with at least one of the second electrode and the third electrode.

28: The overvoltage protection device as recited in claim 25 wherein the resistor includes at least one rounded or beveled edge in mechanical contact with at least one of the first electrode and the second electrode.

29: The overvoltage protection device as recited in claim 25 further comprising a third electrode disposed between the first electrode and the resistor so as to form a second air breakdown spark gap between the first electrode and the third electrode, and wherein the resistor includes at least one rounded or beveled edge in mechanical contact with at least one of the second electrode and the third electrode.

30: The overvoltage protection device as recited in claim 14 wherein the housing includes a metallic pressure housing and an interior insulating housing.
